(19) United States
(12) Patent Application Publication
(10) Pub. No.: US 2015/0140984 A1
(43) Pub. Date: May 21, 2015

(54) Method, system and related device for overriding low priority and/or EAB

(71) Applicant: ZTE Corporation, Chenzhen, Guangdong (CN)

(72) Inventor: Hui Xu, Shenzhen (CN)

(21) Appl. No.: 14/401,703

(22) PCT Filed: May 3, 2013
(86) PCT No.: PCT/CN2013/075139

§ 371 Date: Nov. 17, 2014

(30) Foreign Application Priority Data
May 25, 2012 (CN) 201210166903.8

(51) Int. Cl. H04W 8/22

(52) U.S. Cl. CPC H04W 8/22
USPC 455/418

(57) ABSTRACT

A method, system and related device for overriding low priority and/or Extended Access Bar (EAB) are disclosed. The method includes the following steps: an Open Mobile Alliance (OMA) Device Management (DM) server sends dual-priority User Equipment (UE) a low priority overriding indicator and/or an EAB overriding indicator; and the dual-priority UE determines whether to override low priority and/or EAB according to the low priority overriding indicator and/or the EAB overriding indicator. The disclosure determines an EAB processing manner of dual-priority UE, implements the NAS functional parameter management for the dual-priority UE, and facilitates the application and promotion of the dual-priority UE.

### TECHNICAL FIELD

The disclosure relates to the wireless communication technology, and more particularly to a method, system and related device for overriding low priority and/or Extended Access Bar (EAB).

### BACKGROUND

The Machine to Machine (M2M) technology refers to all the techniques and methods for establishing connection between machines. The M2M idea appeared in the 1990s, but it only remains on the theoretical phase. After the year 2000, with the development of mobile communications technology, it is possible to organize machines to access network by using the mobile communications technology. About from the year 2002, an M2M service starts to appear on the market and develop rapidly in the following years; the M2M service becomes the centre of attention from many communication equipment manufacturers and telecommunication operating companies. At present, people are outnumbered by machines all over the world, thus a good market prospect of the M2M technology can be anticipated in advance.

A study on M2M communication application scenarios shows that providing M2M communication on a mobile network has a potential market prospect. However, the M2M service puts forward a lot of new requirements to system; for strengthening the competitiveness of a mobile network on this aspect, it is necessary to optimize existing mobile network, so as to support the M2M communication more effectively.

Existing mobile communication network is mainly designed aiming at the communication between person and person, thus the communication between machine and machine and the communication between person and machine are not optimized sufficiently. In addition, how an operating company can provide the M2M communication service with low cost is also the key to success in deployment of the M2M communication.

Based on the conditions above, it is necessary to present a solution that the mobile network supports the M2M communication. The solution is required to make maximum reuse of existing network, reduce the influence of lots of M2M communication on a network, and reduce the complexity of operation and maintenance.

Currently, competition on the telecommunication market grows increasingly, the fee is plummeting, the profit margin of operating companies is dropping, and the communication market based on people is tending to be saturated; thus, the M2M technology is a new development opportunity for the operating companies.

For using resources of a mobile network effectively, the 3rd Generation Partnership Project (3GPP) puts forward Machine Type Communication (MTC), including services of M2M communication and Machine to Man communication; the scope of the services is far beyond the past Human to Human (H2H) communication; the MTC is very different from existing H2H communication mode in access control, charging, security, Quality of Service (QoS), service mode and other aspects.

FIG. 1 is a system architecture diagram under a non-roaming scenario in the 3GPP of the prior art. As shown in FIG. 1, an Evolved Packet System (EPS) of 3GPP includes a radio access network (for example, a Universal Mobile Telecommunications System Terrestrial Radio Access Network (UTRAN), an Evolved UTRAN (E-UTRAN), GSM/EDGE Radio Access Network (GERAN)) and a core network. An Evolved Packet Core (EPC) network includes a Mobility Management Entity (MME), a Serving Gateway (SG), a Packet Data Network (PDN) Gateway (PGW) and other network elements; a GPRS core network includes a Serving GPRS Support Node (SGSN) and other elements; the E-UTRAN includes an Evolved Node B (eNB).

There are a large number of User Equipment (UE) with MTC function (which may be called MTC UE), so it may cause network congestion; for avoiding network congestion, a mechanism adopting backoff time is presented in the 3GPP; the mechanism includes a session management backoff timer and a mobility management backoff timer. Generally, the backoff timer is sent, in a rejection message, to the UE by a network side through Non Access Stratum (NAS) signalling. For reducing network load, it is also presented in the 3GPP that Extended Access Bar (EAB) performs access control to the MTC UE.

The MTC UE is generally not sensitive to time delay, so it is considered as UE at low priority. There is a priority indicator and an EAB indicator stored in a Universal Subscriber Identity Module (USIM), for configuring whether UE is at low priority and complies with EAB control. The operating company sends configuration data to the USIM through an Open Mobile Alliance (OMA) Device Management (DM) server. FIG. 2 is a diagram of NAS configuration parameters in a USIM card in the 3GPP version Re1-11; as shown in FIG. 2, in the 3GPP version Re1-11, a low priority indicator and an EAB indicator appear in the USIM simultaneously.

For meeting the requirement of technology development of a mobile network, some MTC applications may have normal priority, such as real-time monitoring and failure reporting; common UE added with an MTC function module may serve as MTC UE; thus, the UE may have dual priority, that is, low priority and normal priority. However, based on the existing technology, there is only a low priority indicator and an EAB indicator in the USIM; the existing technology does not disclose related technical solution about how to indicator the dual priority and how to configure EAB for the dual-priority UE, which facilitates the application and promotion of the dual-priority UE.

### SUMMARY

In view of this, a main purpose of the disclosure is to provide a method, system and related device for overriding low priority and/or EAB, which facilitates the application and promotion of dual-priority UE.

To this end, a technical solution of the disclosure is implemented as follows.

A method for overriding low priority and/or EAB includes that:

an OMA DM server sends dual-priority UE a low priority overriding indicator and/or an EAB overriding indicator; and

the dual-priority UE determines whether to override low priority and/or EAB according to the low priority overriding indicator and/or the EAB overriding indicator.

The method further includes that the dual-priority UE stores the low priority overriding indicator and/or the EAB overriding indicator in a USIM card.

The dual-priority UE determining whether to override low priority and/or EAB according to the low priority overriding indicator and/or the EAB overriding indicator may include that:

after the dual-priority UE initiates a low priority request to the 3GPP network side, and under condition that the dual-priority UE has received an EAB rejection message from the 3GPP network side, if it is determined by the dual-priority UE that the low priority overriding indicator and/or an EAB overriding indicator are/is in the USIM card, and the low priority overriding indicator and/or the EAB overriding indicator indicate/indicates permission to override low priority and/or EAB, then the dual-priority UE overrides the low priority and/or EAB, and initiates a normal priority request to the 3GPP network side; or else, the dual-priority UE does not override the low priority and/or EAB, and fails to initiate a normal priority request to the 3GPP network side; and

after the dual-priority UE initiates a low priority request to the 3GPP network side, and under condition that the dual-priority UE has received a rejection message carrying backoff time from the 3GPP network side, if it is determined by the dual-priority UE that the low priority overriding indicator is in the USIM card, and the low priority overriding indicator indicates permission to override low priority, then the dual-priority UE overrides the low priority, and initiates a normal priority request to the 3GPP network side; or else, the dual-priority UE does not override the low priority, and fails to initiate a normal priority request to the 3GPP network side.

Before the dual-priority UE receives an EAB rejection message from the 3GPP network side, the method further includes that:

an MME/SGSN indicates an EAB parameter to an eNB through NAS signalling; the eNB sends an EAB rejection message to the dual-priority UE after receiving the indication; and the EAB rejection message indicates the EAB parameter.

Before the dual-priority UE receives a rejection message carrying backoff time from the 3GPP network side, the method further includes that an eNB or an MME/SGSN determines backoff time, and sends a rejection message carrying the backoff time to the dual-priority UE.

The request that the dual-priority UE initiates to the 3GPP network side is a mobility management request or a session management request.

A system for overriding low priority and/or EAB includes an OMA DM server and dual-priority UE; wherein,

the OMA DM server is configured to send the dual-priority UE a low priority overriding indicator and/or an EAB overriding indicator; and

the dual-priority UE is configured to determine whether to override low priority and/or EAB according to the low priority overriding indicator and/or the EAB overriding indicator.

The dual-priority UE is further configured to store the low priority overriding indicator and/or the EAB overriding indicator in a USIM card.

The system further includes a 3GPP network side;

the dual-priority UE is specifically configured to, after initiating a low priority request to the 3GPP network side and under condition of receiving an EAB rejection message from the 3GPP network side, determine whether the low priority overriding indicator and/or the EAB overriding indicator are/is in the USIM card, and whether the low priority overriding indicator and/or the EAB overriding indicator indicate/indicates permission to override low priority and/or EAB; if it is determined by the dual-priority UE that the low priority overriding indicator and/or the EAB overriding indicator are/is in the USIM card, and the low priority overriding indicator and/or the EAB overriding indicator indicate/indicates permission to override low priority and/or EAB, then the dual-priority UE overrides the low priority and/or EAB, and initiates a normal priority request to the 3GPP network side; or else, the dual-priority UE does not override the low priority and/or EAB, and fails to initiate a normal priority request to the 3GPP network side; besides, the dual-priority UE is specifically configured to, after initiating a low priority request to the 3GPP network side and under condition of receiving a rejection message carrying backoff time from the 3GPP network side, determine whether the low priority overriding indicator is in the USIM card, and whether the low priority overriding indicator indicates permission to override low priority; if it is determined by the due-priority UE that the low priority overriding indicator is in the USIM card and the low priority overriding indicator indicates permission to override low priority, the dual-priority UE overrides the low priority, and initiates a normal priority request to the 3GPP network side; or else, the dual-priority UE does not override the low priority, and fails to initiate a normal priority request to the 3GPP network side.

The network side includes an MME/SGSN and/or an eNB;

the MME/SGSN is configured to, after receiving a request from the dual-priority UE, indicate an EAB parameter to the eNB through NAS signalling, or, determine backoff time and send the dual-priority UE a rejection message carrying the backoff time; and

the eNB is configured to, after receiving the indication from the MME/SGSN, send an EAB rejection message to the dual-priority UE, wherein the EAB rejection message indicates an EAB parameter, or determine backoff time and send the dual-priority UE a rejection message carrying the backoff time.

An OMA DM server is configured to send dual-priority UE a low priority overriding indicator and/or an EAB overriding indicator.

Dual-priority UE includes a receiving module, a determining module and an executing module; wherein,

the receiving module is configured to receive a low priority overriding indicator and/or an EAB overriding indicator sent by an OMA DM server;

the determining module is configured to determine whether to override low priority and/or EAB according to the low priority overriding indicator and/or the EAB overriding indicator; and

the executing module is configured to execute corresponding operation according to a determination result of the determining module.

The dual-priority UE further includes a USIM card;

the receiving module is further configured to, after receiving the low priority overriding indicator and/or the EAB overriding indicator sent by the OMA DM server, store the low priority overriding indicator and/or the EAB overriding indicator in the USIM card;

the determining module is specifically configured to, after the dual-priority UE initiates a low priority request to the 3GPP network side, and under condition that the dual-priority UE has received an EAB rejection message from the 3GPP network side, determine whether the low priority overriding indicator and/or the EAB overriding indicator are/is in the USIM card, and whether the low priority overriding indicator and/or the EAB overriding indicator indicate/indicates permission to override low priority and/or EAB; if the low priority overriding indicator and/or the EAB overriding indicator are/is in the USIM card, and the low priority overriding indicator and/or the EAB overriding indicator indicate/indicates permission to override low priority and/or EAB, then the determining module determines to override the low priority and/or EAB; or else, the determining module determines not to override the low priority and/or EAB; besides, the determining module is specifically configured to, after the dual-priority UE initiates a low priority request to the 3GPP network side, and under condition that the dual-priority UE has received a rejection message carrying backoff time from the 3GPP network side, determine whether the low priority overriding indicator is in the USIM card, and whether the low priority overriding indicator indicates permission to override low priority; if the low priority overriding indicator is in the USIM card and the low priority overriding indicator indicates permission to override low priority, the determining module determines to override the low priority; or else, the determining module determines not to override the low priority; and

the executing module is specifically configured to, when the determining module determines to override the low priority and/or EAB, initiate a normal priority request to the 3GPP network side; when the determining module determines not to override the low priority and/or EAB, the executing module fails to initiate a normal priority request to the 3GPP network side.

According to the method, system and related device for overriding low priority and/or EAB in the embodiments of the disclosure, an OMA DM server sends dual-priority UE a low priority overriding indicator and/or an EAB overriding indicator; the dual-priority UE determines, according to the low priority overriding indicator and/or the EAB overriding indicator, whether to override low priority and/or EAB. The embodiments of the disclosure determine an EAB processing manner of dual-priority UE, implements NAS functional parameter management for the dual-priority UE, and facilitates the application and promotion of the dual-priority UE.

### BRIEF DESCRIPTION OF THE DRAWINGS

FIG. 1 is a system architecture diagram under a non-roaming scenario in the 3GPP of the existing technology;

FIG. 2 is a diagram of an NAS configuration parameter in a USIM card in the 3GPP version Re1-11;

FIG. 3 is a flowchart of embodiment 1 of the disclosure;

FIG. 4 is a diagram of an NAS configuration parameter in a USIM card of embodiment 1 of the disclosure;

FIG. 5 is a flowchart of embodiment 2 of the disclosure;

FIG. 6 is a flowchart of embodiment 3 of the disclosure;

FIG. 7 is a flowchart of embodiment 4 of the disclosure;

FIG. 8 is a diagram of a connection relationship among an OMA DM server, dual-priority UE, an eNB and an MME/SGSN in an embodiment of the disclosure; and

FIG. 9 is a diagram of a connection relationship between a receiving module and a USIM card which are in the dual-priority UE in an embodiment of the disclosure.

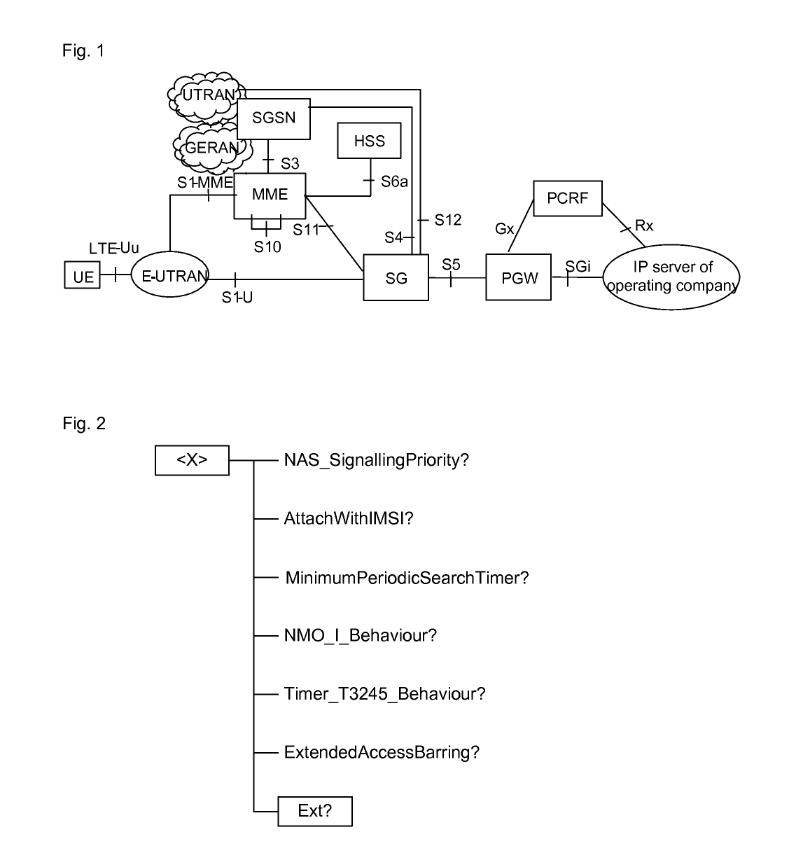

### DETAILED DESCRIPTION

The basic idea of the embodiments of the disclosure is that: an OMA DM server sends a low priority overriding indicator and/or an EAB overriding indicator to dual-priority UE; and the dual-priority UE determines whether to override low priority and/or EAB according to the low priority overriding indicator and/or the EAB overriding indicator.

In an embodiment of the disclosure, an operating company can configure two NAS indicators for the dual-priority UE, one aims at overriding the low priority, and the other aims at overriding the EAB; the indicator usually configures a parameter in a USIM through an OMA DM protocol; it should be noted that it is feasible to only configure any one of the two indicators.

Optionally, the method further includes that: the dual-priority UE stores the low priority overriding indicator and/or the EAB overriding indicator in the USIM card.

Optionally, the dual-priority UE determining whether to override low priority and/or EAB according to the low priority overriding indicator and/or the EAB overriding indicator is that:

after the dual-priority UE initiated a low priority request to the 3GPP network side, and under condition that the dual-priority UE has received an EAB rejection message from the 3GPP network side, if it is determined by the dual-priority UE that a low priority overriding indicator and/or an EAB overriding indicator are/is in the USIM card, and the low priority overriding indicator and/or the EAB overriding indicator indicate/indicates permission to override low priority and/or EAB, then the dual-priority UE overrides the low priority and/or EAB, and initiates a normal priority request to the 3GPP network side; or else, the dual-priority UE does not override the low priority and/or EAB, and can not initiate a normal priority request to the 3GPP network side;

after the dual-priority UE initiated a low priority request to the 3GPP network side, and under condition that the dual-priority UE has received a rejection message carrying backoff time from the 3GPP network side, if it is determined by the dual-priority UE that a low priority overriding indicator is in the USIM card, and the low priority overriding indicator indicates permission to override low priority, then the dual-priority UE overrides the low priority, and initiates a normal priority request to the 3GPP network side; or else, the dual-priority UE does not override the low priority, and cannot initiate a normal priority request to the 3GPP network side;

if the dual-priority UE receives a rejection message carrying backoff time from the 3GPP network side after initiating a normal priority request to the 3GPP network side, the dual-priority UE cannot initiate a subsequent request before release or relief of the network side congestion.

The dual-priority UE will report corresponding priority to the network side when initiating a request (such as a mobility management request or a session management request); for example, the dual-priority UE indicates priority when initiating a PDN connection request; generally, different priority requests correspond to different PDN connections.

Optionally, before the dual-priority UE receives an EAB rejection message from the 3GPP network side, the method further includes that: an MME/SGSN indicates an EAB parameter to an eNB through NAS signalling; the eNB sends an EAB rejection message to the dual-priority UE after receiving the indication; and the EAB rejection message indicates the EAB parameter.

Optionally, before the dual-priority UE receives a rejection message carrying backoff time from the 3GPP network side, the method further includes that: an eNB or an MME/SGSN determines backoff time, and sends a rejection message carrying the backoff time to the dual-priority UE.

Optionally, a request that the dual-priority UE initiates to the 3GPP network side is a mobility management request or a session management request.

Correspondingly, an embodiment of the disclosure further discloses a system for overriding low priority and/or EAB; the system includes an OMA DM server and dual-priority UE; wherein,

the OMA DM server is configured to send a low priority overriding indicator and/or an EAB overriding indicator to the dual-priority UE; and

the dual-priority UE is configured to determine whether to override low priority and/or EAB according to the low priority overriding indicator and/or the EAB overriding indicator.

Optionally, the dual-priority UE is further configured to store the low priority overriding indicator and/or the EAB overriding indicator in a USIM card.

Optionally, the system further includes a 3GPP network side;

the dual-priority UE is specifically configured to, after initiating a low priority request to the 3GPP network side and under condition of receiving an EAB rejection message from the 3GPP network side, determine whether a low priority overriding indicator and/or an EAB overriding indicator are/is in the USIM card, and whether the low priority overriding indicator and/or the EAB overriding indicator indicate/indicates permission to override low priority and/or EAB; if it is determined that a low priority overriding indicator and/or an EAB overriding indicator are/is in the USIM card, and the low priority overriding indicator and/or the EAB overriding indicator indicate/indicates permission to override low priority and/or EAB, then the dual-priority UE overrides the low priority and/or EAB, and initiates a normal priority request to the 3GPP network side; or else, the dual-priority UE does not override the low priority and/or EAB, and cannot initiate a normal priority request to the 3GPP network side; besides, the dual-priority UE is specifically configured to, after initiating a low priority request to the 3GPP network side and under condition of receiving a rejection message carrying backoff time from the 3GPP network side, determine whether a low priority overriding indicator is in the USIM card, and whether the low priority overriding indicator indicates permission to override low priority; if it is determined that a low priority overriding indicator is in the USIM card and the low priority overriding indicator indicates permission to override low priority, the dual-priority UE overrides the low priority, and initiates a normal priority request to the 3GPP network side; or else, the dual-priority UE does not override the low priority, and cannot initiate a normal priority request to the 3GPP network side; furthermore, the dual-priority UE is specifically configured to, after initiating a normal priority request to the 3GPP network side and under condition of receiving a rejection message carrying backoff time from the 3GPP network side, not initiate a subsequent request before release or relief of the network side congestion.

Optionally, the network side includes an MME/SGSN and/or an eNB;

the MME/SGSN is configured to, after receiving a request from the dual-priority UE, indicate an EAB parameter to the eNB through NAS signalling, or, determine backoff time and send the dual-priority UE a rejection message carrying the backoff time; and

the eNB is configured to, after receiving the indication from the MME/SGSN, send an EAB rejection message to the dual-priority UE, wherein the EAB rejection message indicates an EAB parameter, or determine backoff time and send the dual-priority UE a rejection message carrying the backoff time.

Correspondingly, an embodiment of the disclosure further discloses an OMA DM server; the OMA DM server is configured to send a low priority overriding indicator and/or an EAB overriding indicator to dual-priority UE.

Correspondingly, an embodiment of the disclosure further discloses dual-priority UE; the dual-priority UE includes a receiving module, a determining module and an executing module; wherein,

the receiving module is configured to receive a low priority overriding indicator and/or an EAB overriding indicator sent by an OMA DM server;

the determining module is configured to determine whether to override low priority and/or EAB according to the low priority overriding indicator and/or the EAB overriding indicator; and

the executing module is configured to execute corresponding operation according to a determination result of the determining module.

Optionally, the dual-priority UE further includes a USIM card;

the receiving module is further configured to, after receiving a low priority overriding indicator and/or an EAB overriding indicator sent by the OMA DM server, store the low priority overriding indicator and/or the EAB overriding indicator in the USIM card.

Optionally, the determining module is specifically configured to, after the dual-priority UE initiates a low priority request to the 3GPP network side, and under condition that the dual-priority UE has received an EAB rejection message from the 3GPP network side, determine whether a low priority overriding indicator and/or an EAB overriding indicator are/is in the USIM card, and whether the low priority overriding indicator and/or the EAB overriding indicator indicate/indicates permission to override low priority and/or EAB; if it is determined that a low priority overriding indicator and/or an EAB overriding indicator are/is in the USIM card, and the low priority overriding indicator and/or the EAB overriding indicator indicate/indicates permission to override low priority and/or EAB, then the determining module determines to override the low priority and/or EAB; or else, the determining module determines not to override the low priority and/or EAB; besides, the determining module is specifically configured to, after the dual-priority UE initiates a low priority request to the 3GPP network side, and under condition that the dual-priority UE has received a rejection message carrying backoff time from the 3GPP network side, determine whether a low priority overriding indicator is in the USIM card, and whether the low priority overriding indicator indicates permission to override low priority; if it is determined that a low priority overriding indicator is in the USIM card and the low priority overriding indicator indicates permission to override low priority, the determining module determines to override the low priority; or else, the determining module determines not to override the low priority; furthermore, the determining module is specifically configured to, after initiating a normal priority request to the 3GPP network side and under condition of receiving a rejection message carrying backoff time from the 3GPP network side, not initiate a subsequent request before determining release or relief of the network side congestion;

the executing module is specifically configured to, when the determining module determines to override the low priority and/or EAB, initiate a normal priority request to the 3GPP network side; when the determining module determines not to override the low priority and/or EAB, the executing module cannot subsequently initiate a normal priority request to the 3GPP network side.

Through the embodiments of the disclosure, the NAS functional parameter management for the dual-priority UE can be implemented, thus facilitating the application and promotion of the dual-priority UE. The disclosure is elaborated below in combination with embodiments.

### Embodiment 1

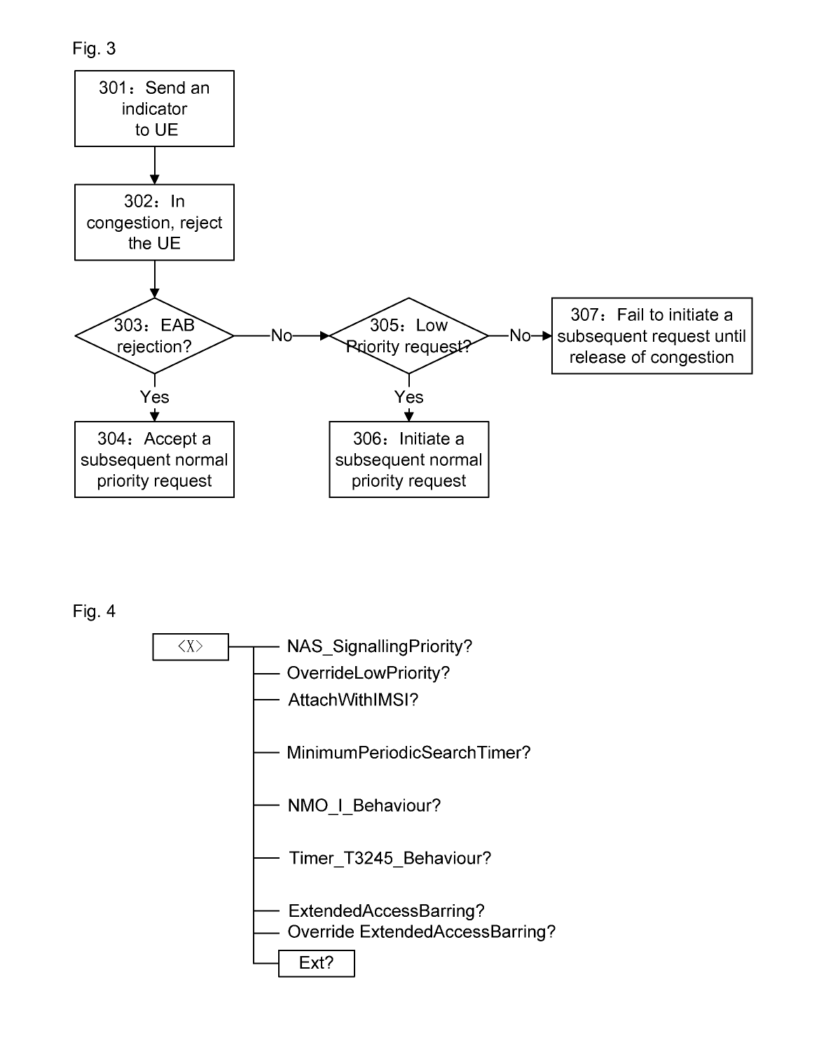

FIG. 3 is a flowchart of embodiment 1 of the disclosure; as shown in FIG. 3, the flow includes the following steps.

Step 301: An operating company sends indicator data to dual-priority UE, and the dual-priority UE stores the indicator data in a USIM card.

Here, the operating company sends the indicator data to the UE through an OMA DM server; the sending may be carried out by using the Over the Air (OTA) technology; the dual-priority UE may be the UE simultaneously supporting low priority access and normal priority access.

The indicator data includes a low priority overriding indicator and an EAB overriding indicator; optionally, the indicator includes two values, that is, 1 and 0; wherein, 1 indicates permission to override, and 0 indicates prohibition to override. In this embodiment, both the low priority overriding indicator and the EAB overriding indicator indicate permission to override. The diagram of an NAS configuration parameter in the USIM card of this embodiment is shown in FIG. 4.

STEP 302: A network side is in congestion, a UE request from the dual-priority UE is rejected.

Here, the network side may include at least one of the followings: an eNB, an MME and an SGSN; the congestion may be the access network congestion or the core network congestion;

the UE request may be rejected through the backoff time of network side or the EAB, which depends on the network side; the UE request includes the mobility management request or the session management request; if the UE initiates a PDN connection request, the PDN connections that the different priorities correspond to are different, and different PDN connections may belong to the same or different Access Point Name (APN).

STEP 303: The dual-priority UE determines whether it is an EAB rejection, if it is an EAB rejection, STEP 304 is then executed; or else, STEP 305 is then executed.

The EAB rejection means that an eNB sends an EAB rejection message to the dual-priority UE according to NAS indication.

STEP 304: The dual-priority UE initiates a subsequent normal priority request to the network side, and the network side accepts the subsequently initiated normal priority request.

It should be noted that, bearing the EAB rejection by the dual-priority UE means that the request is a low priority request; the subsequent normal priority request means a normal priority request that the same UE initiates subsequently.

STEP 305: The dual-priority UE determines whether the rejected UE request is a low priority request; if it is a low priority request, then STEP 306 is executed; or else, STEP 307 is executed.

If the UE request is not rejected by the EAB, and the request is rejected by the backoff time carried by the network side; then, the request may be at low priority or normal priority.

STEP 306: The dual-priority UE may initiate the subsequent normal priority request.

If the request is a low priority request, the subsequent normal priority request from the dual-priority UE is not influenced by the current backoff time, that is, the dual-priority UE may initiate a normal priority request.

STEP 307: The dual-priority UE cannot initiate a subsequent request until release or relief of congestion.

If the request is a normal priority request, the dual-priority UE is controlled by the current backoff time and cannot initiate a subsequent request; the subsequent request includes a low priority request and a normal priority request.

The UE may initiate a request subsequently after release or relief of congestion.

### Embodiment 2

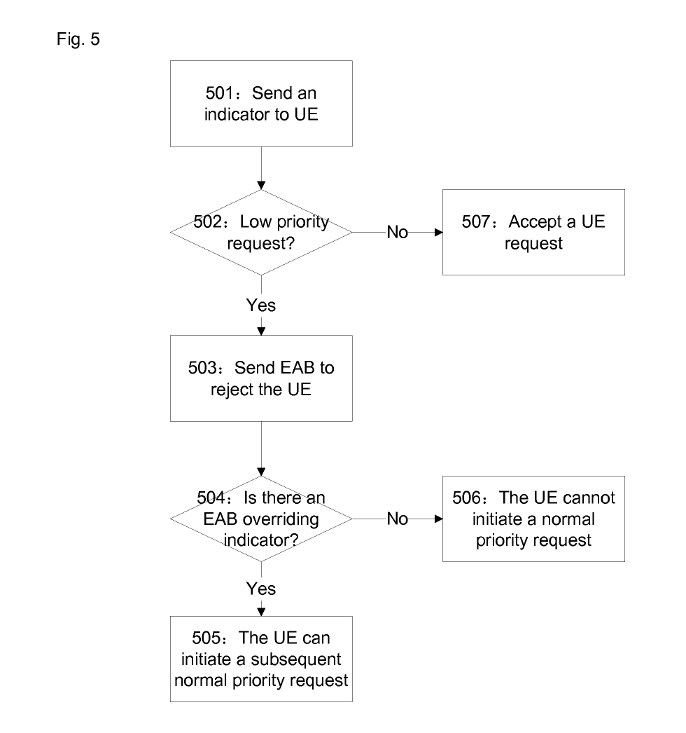

The scenario of the embodiment is that a network is in congestion, and a low priority request is rejected by the EAB. FIG. 5 is a flowchart of embodiment 2 of the disclosure; as shown in FIG. 5, the flow includes the following steps.

STEP 501: An operating company sends a dual-priority indicator parameter to dual-priority UE.

This step is same as STEP 301, so it will not be repeated here.

STEP 502: A network side is in congestion, determining whether a UE request from the dual-priority UE is a low priority request; if it is a low priority request, STEP 503 is then executed; or else, STEP 507 is then executed.

The low priority request is indicatorged by a request message initiated by the dual-priority UE; if the request has a low priority indicator, then it is a low priority request; or else, it is a normal priority request.

STEP 503: The network side sends EAB to reject the UE request.

The network side indicates the EAB to an eNB through NAS signalling; after receiving the indication, the eNB sends a system message to the dual-priority UE to indicate an EAB parameter;

when receiving the EAB indication, the dual-priority UE determines, according to an EAB configuration parameter in the USIM card, whether to bear an EAB control; if the UE determines to bear the EAB control, then the UE request is rejected. The dual-priority UE in the embodiment is supposed to bear the EAB control.

STEP 504: The dual-priority UE determines whether an EAB overriding indicator are/is in the USIM card; if an EAB overriding indicator are/is in the USIM card and the indicator indicates permission to override, STEP 505 is then executed; or else, STEP 506 is then executed.

The EAB overriding indicator means that if the parameter in the USIM card is 1, it is permitted to override the EAB or a normal priority does not bear the EAB control;

It should be noted that, generally, the EAB overriding indicator and the low priority overriding indicator appear simultaneously.

STEP 505: The dual-priority UE may initiate a normal priority request subsequently.

The dual-priority UE may initiate a normal priority request; the request may adopt different PDN connections, which belong to the same or different APNs.

It should be noted that in the current version Re1-11, the EAB only aims at the low priority request, but the subsequent version does not exclude the situation that the EAB aims the normal priority request.

STEP 506: The dual-priority UE cannot initiate a normal priority request.

STEP 507: The network side accepts the normal priority request initiated by the UE, and the flow ends.

### Embodiment 3

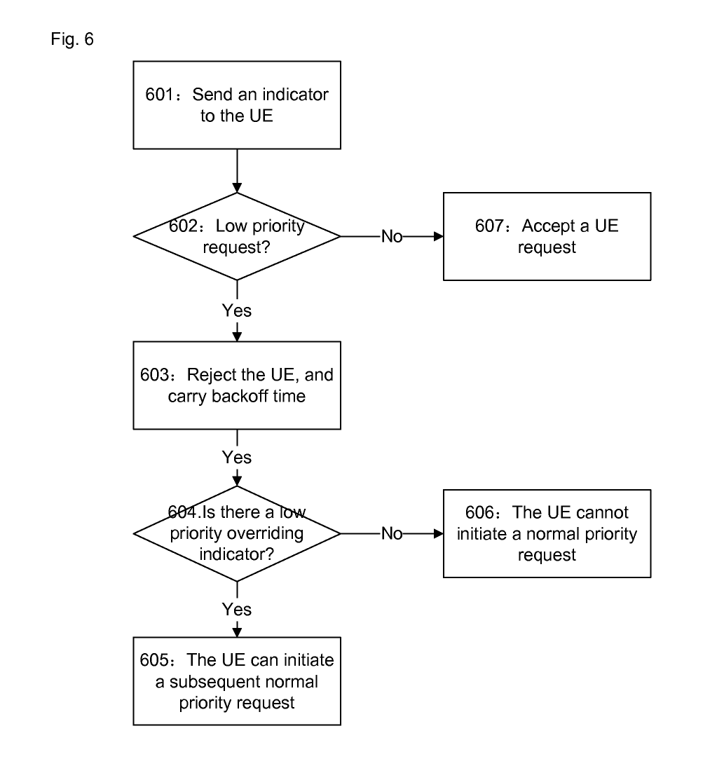

The scenario of the embodiment is that a network is in congestion, and a network side carries backoff time to reject a low priority request. FIG. 6 is a flowchart of embodiment 3 of the disclosure; as shown in FIG. 6, the flow includes the following steps.

STEP 601: An operating company sends a dual-priority indicator parameter to UE.

This step is same as STEP 401, so it will not be repeated here.

STEP 602: The network side is in congestion, determining whether a UE request initiated by the dual-priority UE is a low priority request; if it is a low priority request, STEP 603 is then executed; or else, STEP 607 is then executed.

This step is same as STEP 502, so it will not be repeated here.

STEP 603: The network side sends a rejection message to the dual-priority UE, and carries the backoff time in the rejection message.

The network side is at least one of the followings: an eNB, an MME and an SGSN;

the rejection message is a Radio Resource Control (RRC) rejection message or an NAS rejection message;

the backoff time indicates that the UE should not initiate the same request in corresponding time.

STEP 604: The dual-priority UE determines whether a low priority overriding indicator is in the USIM card; if it is in the USIM card, STEP 605 is then executed; or else, STEP 606 is then executed.

The low priority overriding indicator means that if the parameter in the USIM card is 1, it is permitted to override the low priority or initiate a normal priority request.

It should be noted that, in the current version, the EAB overriding indicator and the low priority overriding indicator appear simultaneously.

STEP 605: The dual-priority UE may initiate a subsequent normal priority request.

If the low priority request of the dual-priority UE is rejected, the dual-priority UE may initiate a normal priority request subsequently;

the normal priority request and the low priority request belong to the same application.

STEP 606: The dual-priority UE cannot initiate a normal priority request.

STEP 607: The network side accepts a UE request from the dual-priority UE.

The network side accepts a normal priority request initiated by the dual-priority UE.

### Embodiment 4

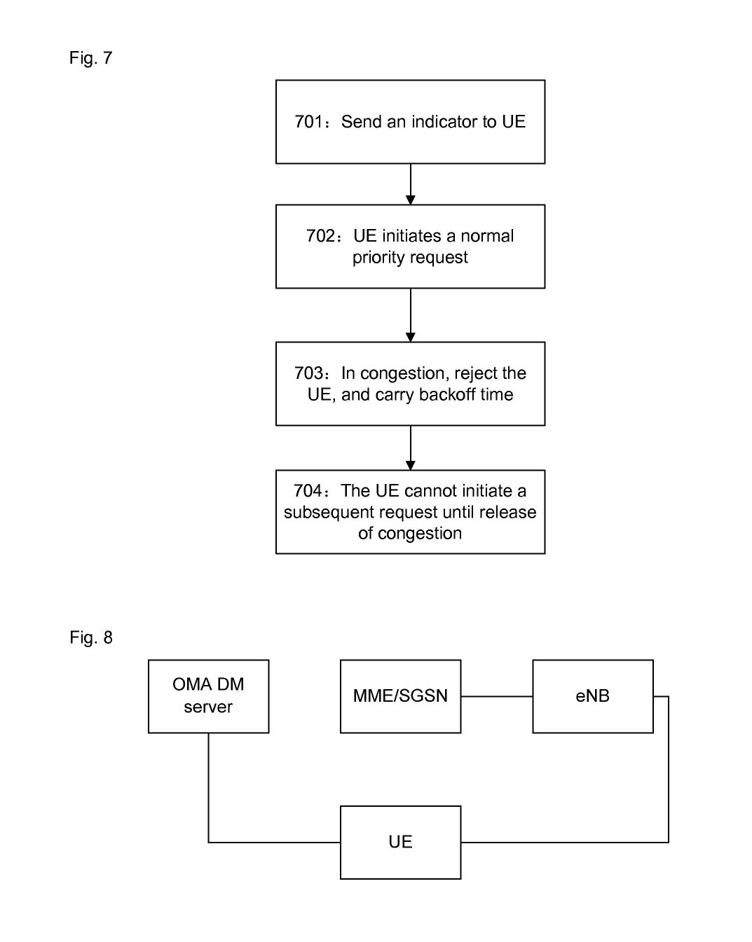

The scenario of the embodiment is that a network is in congestion, and a network side carries backoff time to reject a low priority request. FIG. 7 is a flowchart of embodiment 4 of the disclosure; as shown in FIG. 7, the flow includes the following steps.

STEP 701: An operating company sends a dual-priority indicator parameter to UE.

This step is same as STEP 401, so it will not be repeated here.

STEP 702: The dual-priority UE initiates a normal priority request.

STEP 703: The network side is in congestion; the network side sends a rejection message to the dual-priority UE, and includes backoff time in the rejection message.

STEP 704: The dual-priority UE cannot initiate a subsequent request until release or relief of congestion.

The subsequent request includes a low priority request and a normal priority request; the dual-priority UE cannot initiate request until release or relief of congestion.

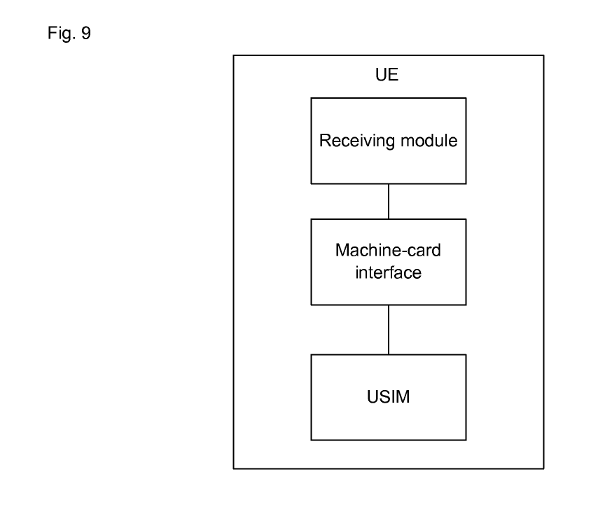

It should be noted that, in the embodiment of the disclosure, the connection relationship of an OMA DM server, dual-priority UE, an eNB and an MME/SGSN is shown in FIG. 8; there is a machine-card interface configured between the receiving module and the USIM card in the dual-priority UE; the detailed structure of the machine-card interface is shown in FIG. 9.

The above are only the preferred embodiments of the disclosure, and not intended to limit the scope of the claims of the disclosure.

What is claimed is:

1. A method for overriding low priority and/or Extended Access Bar (EAB), comprising:
sending, by an Open Mobile Alliance (OMA) Device Management (DM) server, a low priority overriding indicator and/or an EAB overriding indicator to dual-priority User Equipment (UE); and
determining, by the dual-priority UE, whether to override low priority and/or EAB according to the low priority overriding indicator and/or the EAB overriding indicator.

2. The method according to claim 1, further comprising:
storing, by the dual-priority UE, the low priority overriding indicator and/or the EAB overriding indicator in a Universal Subscriber Identity Module (USIM) card.

3. The method according to claim 2, wherein determining, by the dual-priority UE, whether to override low priority and/or EAB according to the low priority overriding indicator and/or the EAB overriding indicator comprises that:
after the dual-priority UE initiates a low priority request to a 3rd Generation Partnership Project (3GPP) network side and under condition that the dual-priority UE has received an EAB rejection message from the 3GPP network side, if the dual-priority UE determines that the low priority overriding indicator and/or the EAB overriding indicator are/is in the USIM card, and the low priority overriding indicator and/or the EAB overriding indicator indicate/indicates permission to override the low priority and/or the EAB, then the dual-priority UE overrides the low priority and/or the EAB, and initiates a normal priority request to the 3GPP network side; or else, the dual-priority UE does not override the low priority and/or the EAB, and fails to initiate a normal priority request to the 3GPP network side;
after the dual-priority UE initiates a low priority request to the 3GPP network side, and under condition that the dual-priority UE has received a rejection message carrying backoff time from the 3GPP network side, if the dual-priority UE determines that the low priority overriding indicator is in the USIM card, and the low priority overriding indicator indicates permission to override the low priority, then the dual-priority UE overrides the low priority, and initiates a normal priority request to the 3GPP network side; or else, the dual-priority UE does not override the low priority, and fails to initiate a normal priority request to the 3GPP network side.

4. The method according to claim 3, before receiving, by the dual-priority UE, the EAB rejection message from the 3GPP network side, further comprising:
indicating, by a Mobility Management Entity (MME)/Serving GPRS Support Node (SGSN), an EAB parameter to an Evolved Node B (eNB) through Non Access Stratum (NAS) signalling; and sending, by the eNB, an EAB rejection message to the dual-priority UE after receiving the indication, wherein the EAB rejection message indicates the EAB parameter.

5. The method according to claim 3, before receiving, by the dual-priority UE, the rejection message carrying backoff time from the 3GPP network side, further comprising:
determining, by the eNB or the MME/SGSN, backoff time, and sending a rejection message carrying the backoff time to the dual-priority UE.

6. The method according to claim 3, wherein the request that the dual-priority UE initiates to the 3GPP network side is a mobility management request or a session management request.

7. A system for overriding low priority and/or Extended Access Bar (EAB), comprising an Open Mobile Alliance (OMA) Device Management (DM) server, and dual-priority User Equipment (UE); wherein
the OMA DM server is configured to send the dual-priority UE a low priority overriding indicator and/or an EAB overriding indicator; and
the dual-priority UE is configured to determine whether to override low priority and/or EAB according to the low priority overriding indicator and/or the EAB overriding indicator.

8. The system according to claim 7, wherein the dual-priority UE is further configured to store the low priority overriding indicator and/or the EAB overriding indicator in a Universal Subscriber Identity Module (USIM) card.

9. The system according to claim 8, further comprising a 3rd Generation Partnership Project (3GPP) network side;
wherein the dual-priority UE is specifically configured to, after initiating a low priority request to the 3GPP network side and under condition of receiving an EAB rejection message from the 3GPP network side, determine whether the low priority overriding indicator and/or the EAB overriding indicator are/is in the USIM card, and whether the low priority overriding indicator and/or the EAB overriding indicator indicate/indicates permission to override the low priority and/or the EAB; if the dual-priority UE determines that the low priority overriding indicator and/or the EAB overriding indicator are/is in the USIM card, and the low priority overriding indicator and/or the EAB overriding indicator indicate/indicates permission to override the low priority and/or the EAB, then the dual-priority UE overrides the low priority and/or the EAB, and initiates a normal priority request to the 3GPP network side; or else, the dual-priority UE does not override the low priority and/or the EAB, and fails to initiate a normal priority request to the 3GPP network side; and,
the dual-priority UE is specifically configured to, after initiating a low priority request to the 3GPP network side and under condition of receiving a rejection message carrying backoff time from the 3GPP network side, determine whether the low priority overriding indicator is in the USIM card, and whether the low priority overriding indicator indicates permission to override the low priority; if the dual-priority UE determines that the low priority overriding indicator is in the USIM card and the low priority overriding indicator indicates permission to override the low priority, the dual-priority UE overrides the low priority, and initiates a normal priority request to the 3GPP network side; or else, the dual-priority UE does not override the low priority, and fails to initiate a normal priority request to the 3GPP network side.

10. The system according to claim 9, wherein the network side comprises a Mobility Management Entity (MME)/Serving GPRS Support Node (SGSN) and/or an Evolved Node B (eNB);
wherein the MME/SGSN is configured to, after receiving a request from the dual-priority UE, indicate an EAB parameter to the eNB through Non Access Stratum (NAS) signalling, or, determine backoff time and send the dual-priority UE a rejection message carrying the backoff time; and
the eNB is configured to, after receiving the indication from the MME/SGSN, send the dual-priority UE an EAB rejection message which indicates an EAB parameter, or determine backoff time and send the dual-priority UE a rejection message carrying the backoff time.

11. An Open Mobile Alliance (OMA) Device Management (DM) server, configured to send dual-priority User Equipment (UE) a low priority overriding indicator and/or an Extended Access Barring (EAB) overriding indicator.

12. Dual-priority User Equipment (UE) comprising a receiving module, a determining module and an executing module; wherein
the receiving module is configured to receive a low priority overriding indicator and/or an Extended Access Barring (EAB) overriding indicator sent by an Open Mobile Alliance (OMA) Device Management (DM) server;
the determining module is configured to determine whether to override low priority and/or EAB according to the low priority overriding indicator and/or the EAB overriding indicator; and
the executing module is configured to execute corresponding operation according to a determination result of the determining module.

13. The dual-priority UE according to claim 12, further comprising a Universal Subscriber Identity Module (USIM) card;
wherein the receiving module is further configured to, after receiving the low priority overriding indicator and/or the EAB overriding indicator sent by the OMA DM server, store the low priority overriding indicator and/or the EAB overriding indicator in the USIM card.

14. The dual-priority UE according to claim 12, wherein
the determining module is specifically configured to, after the dual-priority UE initiates a low priority request to a 3rd Generation Partnership Project (3GPP) network side, and under condition that the dual-priority UE has received an EAB rejection message from the 3GPP network side, determine whether the low priority overriding indicator and/or the EAB overriding indicator are/is in a USIM card, and whether the low priority overriding indicator and/or the EAB overriding indicator indicate/indicates permission to override the low priority and/or the EAB; if the low priority overriding indicator and/or the EAB overriding indicator are/is in the USIM card, and the low priority overriding indicator and/or the EAB overriding indicator indicate/indicates permission to override the low priority and/or the EAB, then the determining module is configured to determine to override the low priority and/or the EAB; or else, the determining module is configured to determine not to override the low priority and/or EAB; and,
the determining module is specifically configured to, after the dual-priority UE initiates a low priority request to the 3GPP network side, and under condition that the dual-priority UE has received a rejection message carrying backoff time from the 3GPP network side, determine whether the low priority overriding indicator is in the USIM card, and whether the low priority overriding indicator indicates permission to override the low priority; if the low priority overriding indicator is in the USIM card and the low priority overriding indicator indicates permission to override low priority, the determining module is configured to determine to override the low priority; or else, the determining module is configured to determine not to override the low priority; and
the executing module is specifically configured to, when the determining module determines to override the low priority and/or the EAB, initiate a normal priority request to the 3GPP network side; when the determining module determines not to override the low priority and/or the EAB, the executing module fails to initiate a normal priority request to the 3GPP network side.

15. The method according to claim 4, wherein the request that the dual-priority UE initiates to the 3GPP network side is a mobility management request or a session management request.

16. The method according to claim 5, wherein the request that the dual-priority UE initiates to the 3GPP network side is a mobility management request or a session management request.
